(19) United States
(12) Patent Application Publication
(10) Pub. No.: US 2005/0286830 A1
(43) Pub. Date: Dec. 29, 2005

(54) Optical delay device and transmission system including such a delay device

(75) Inventors: Antonello Cutolo, Benevento (IT); Guido Chiaretti, Novate Milanese MI (IT); Antonio Fincato, Cameri NO (IT)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: STMICROELECTRONICS S.r.l., AGRATE BRIANZA (IT)

(21) Appl. No.: 11/151,694

(22) Filed: Jun. 13, 2005

(30) Foreign Application Priority Data
Jun. 14, 2004 (IT) MI2004A001186

(51) Int. Cl. G02B 6/26

(52) U.S. Cl. 385/27

(57) ABSTRACT

A delay device is provided that includes at least one first optical guide for receiving an optical signal, and at least one optical means for outputting a delayed optical signal. A plurality of total signal reflection means are placed along the first optical guide, and a plurality of second optical guides are placed between the reflection means of the plurality of reflection means and the at least one optical means. An activation means activates at least one of the reflection means, and selection means select which of the reflection means of the plurality of reflection means is to be activated to obtain a desired delay on the optical path of the optical signal. The reflection means are placed in succession along the first optical guide. Also provided is a transmission system that includes at least one laser source, an emission source, and at least one such optical delay device.

### CROSS-REFERENCE TO RELATED APPLICATIONS

This application is based upon and claims priority from prior Italian Patent Application No. M12004A001186, filed Jun. 14, 2004, the entire disclosure of which is herein incorporated by reference.

### FIELD OF THE INVENTION

The present invention relates to an optical delay device and a transmission system that includes such a delay device.

### BACKGROUND OF THE INVENTION

There are conventional transmission systems that use a radiating apparatus made of an array of antennas that permits the generation of a particular distribution of the electromagnetic field to concentrate the energy only in several directions. This is obtained by controlling the phase delays relating to each signal that feeds the single radiating element. The advantage is to increase the efficiency of the electromagnetic connection by diminishing at the same time the electromagnetic pollution in the zones in which receivers are not present.

In addition, by changing the delays relating to each radiating element, it is possible to reconfigure the angular distribution of the energy that is radiated.

To achieve these objects, there can be used devices in which the electrical signal is transformed into an optical signal by a laser diode and divided on N identical optical paths. On each of these paths it is possible to apply an optical delay more efficiently and more precisely than is possible at the electrical level. For this object, a variable optical delay device is formed with an electromechanical system of lens and mobile mirrors. This system, however, is not very practical and is costly and not very reliable.

In the conventional device, the delayed signals are sent to some photo detectors, and are then amplified and sent to an antenna that radiates the signals.

The electromechanical delay devices are very expensive and in addition are subject to breakdowns of the mechanical device.

### SUMMARY OF THE INVENTION

It is an object of the present invention to provide a different type of optical delay device that overcomes the disadvantages of the conventional devices.

In accordance with one embodiment of the present invention, a delay device is provided. The delay device includes at least one first optical guide for receiving an optical signal and at least one optical means for outputting a delayed optical signal. A plurality of total signal reflection means are positioned along the first optical guide, and a plurality of second optical guides are positioned between the reflection means of the plurality of reflection means and the at least one optical means. Activation means activate at least one of the reflection means, and selection means select which of the reflection means of the plurality of reflection means to activate to obtain a desired delay on the optical path of the optical signal. The reflection means are positioned in succession at a distance from one another along the first optical guide. In some embodiments, the reflection means are placed at different distances from one another in the succession. In other embodiments, the reflection means are placed at equal distances from on another in the succession.

In accordance with another embodiment of the present invention, a transmission system is provided. The transmission system includes at least one laser source for transmitting an optical signal, an emission source for the signals, and at least one such optical delay device for delaying the optical signal.

Other objects, features, and advantages of the present invention will become apparent from the following detailed description. It should be understood, however, that the detailed description and specific examples, while indicating preferred embodiments of the present invention, are given by way of illustration only and various modifications may naturally be performed without deviating from the present invention.

### BRIEF DESCRIPTION OF THE DRAWINGS

FIG. 1 is a view of a transmission system that includes a delay device according to a first embodiment of the present invention;

FIG. 2 is a more detailed view of the delay device of FIG. 1;

FIG. 3 is a view of a delay device according to a second embodiment of the present invention;

FIG. 4 is a view of a delay device according to another embodiment of the present invention;

FIG. 5 is a view of delay lines that can be used in a delay device according to the present invention; and

FIG. 6 is a view of a resistance that can be used in a delay device according to the present invention.

### DETAILED DESCRIPTION OF PREFERRED EMBODIMENTS

Preferred embodiments of the present invention will be described in detail hereinbelow with reference to the attached drawings.

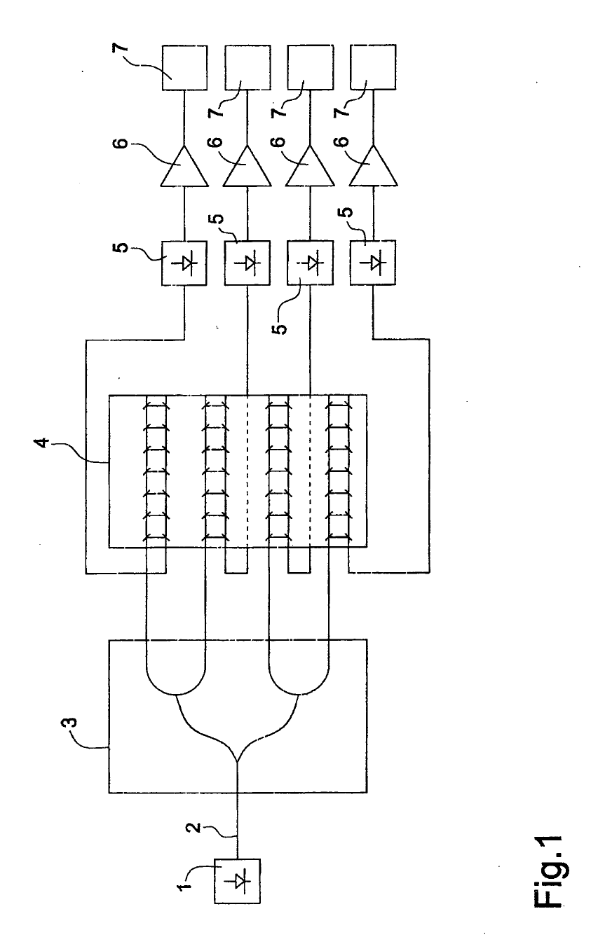

FIG. 1 shows a transmission system comprising an optical delay device according to a first embodiment of the present invention. The transmission system comprises a laser source 1 suitable for transmitting an optical signal, that is a laser beam carrying a radio frequency signal, in an optical guide 2, for example an optical fiber. An optical splitter 3, preferably of the integrated type, for dividing the optical signal while keeping constant the phase relation is positioned downstream from the optical fiber 2. In the exemplary embodiment of FIG. 1, the optical splitter 3 has four outputs. Each output is connected to an optical delay device 4 for delaying the optical signal by the quantity of time that is required. The optical signal output from the delay device 4 is sent to a photodetector 5 and is successively amplified by an amplifier 6 and sent to an antenna 7, preferably a phased array antenna.

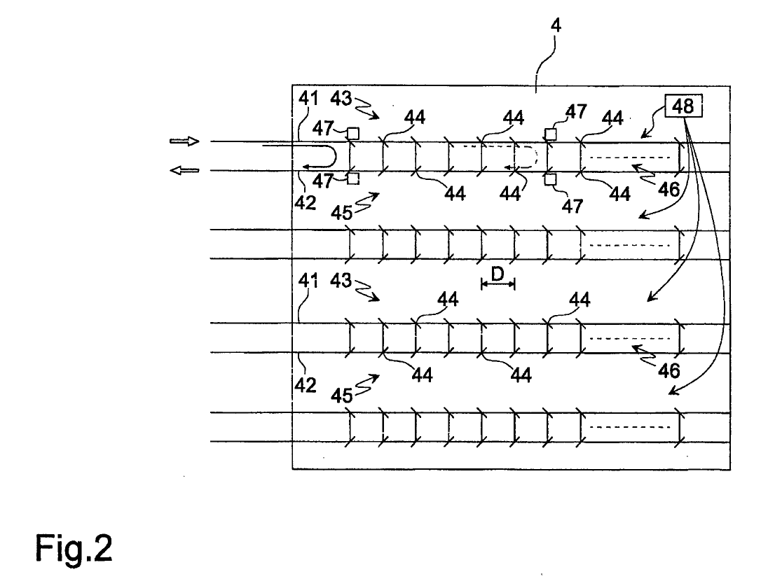

The optical delay device 4, shown in more detail in FIG. 2, is preferably made in a single chip and comprises at least one first optical guide 41 for the input of the optical signal and at least a second optical guide 42 for the output of the delayed optical signal, with a first plurality 43 of total signal reflection means 44 of the optical signal positioned on the first optical guide 41 and a second plurality 45 of corresponding total signal reflection means 44 of the optical signal positioned on the second optical guide 42. The delay device comprises a plurality of further optical guides 46 placed between the corresponding reflection means 44 of the first plurality 43 of reflection means and the second plurality 45 of reflection means. The total reflection means 44 of the optical signal are normally inactive. The optical delay device comprises activation means 47 for activating one of the total reflection means 44 of the first plurality 43 and the corresponding total reflection means 44 of the second plurality 45.

The total reflection means 44 of the first plurality 43 and the second plurality 45 are positioned in succession at a set distance D from one another along the first 41 and second 42 optical guides. They can be positioned at a constant equal distance from one another, for example at a distance D=250 μm, or the relative distances D between the various reflection means 44 in the succession can be different from each other. The delay device 4 comprises selection means 48 suitable for selecting which of the total reflection means 44 of the first plurality 43 and its corresponding reflection means 44 of the second plurality 45 to be activated to obtain the required delay of the optical path of the signal. In this manner there is obtained a controlled delay of the optical path of the signal which is variable between 2D and 2nD, where n is the number of the reflection means 44 positioned in each optical guide. The activation means 47 are preferably positioned adjacent to the total reflection means 44 and can be positioned in a different chip from the chip of the delay device 4. The selection means 48 of this embodiment comprise an electronic circuit that is programmed so as to excite the activation means 47.

The total reflection means 44 can be made of the optical switches described in U.S. Pat. No. 6,324,316 to Fouquet et al., the entire disclosure of which is herein incorporated by reference. These optical switches are made of a suitable crossover of two optical guides and a groove with perfectly vertical walls filled with a refraction index liquid adapted to that of the guides. One of the walls of the groove is positioned on an ideal surface on which a mirror suitable for reflecting the light guided by a guide to that which intersects it should lie. An electrode placed above the groove and belonging to a second chip, which also has the task of closing hermetically, locally heats the liquid creating a suitable bubble of vapor that uncovers the vertical surfaces of the groove. The refraction index of the vapor is near 1 and if the angle generated by the wall of the groove with the optical guide is suitable there is a total internal reflection. The activation of the electrode, that represents the activation means 47, thus permits the deviation of the light guided from one to the other of the two intersecting guides that form the optical switch.

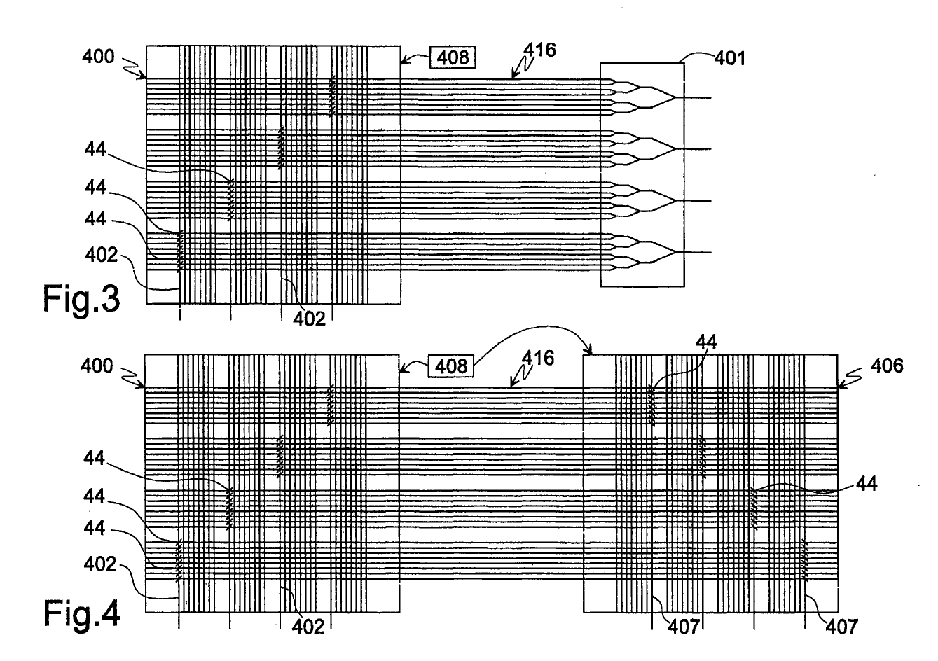

FIG. 3 shows an optical delay device in accordance with a second embodiment of the present invention. The device comprises an optical matrix 400 with four groups of eight optical guides for the input of the optical signal, and an optical splitter 401 suitable for outputting the delayed optical signal. In the optical matrix 400 of this embodiment, each optical guide 402 is made like the optical guide 41 or 42 described above (that is, it comprises a plurality of total reflection means 44 placed in succession at a given distance D from one another, with the reflection means 44 normally inactive). The optical delay device comprises selection means 408 suitable for selecting which of the reflection means 44 must be activated in accordance with the optical delay that is required, and suitable for controlling the activation means 47. The optical signal that flows through an optical guide 402 is reflected by the activated reflection means 44 and is sent, by one of the optical guides 416, to an optical splitter 405 and then to the photo detectors 5. In the case in which the number of optical means is n, there is a variable delay of the signal of between D and nD.

In another embodiment of the present invention shown in FIG. 4, in the place of the optical splitter 401 another optical matrix 406 is inserted, which is similar to the optical matrix 400 with optical guides 407 made like the optical guides 402, with total reflection means 44 placed in succession at a distance D from one another. In this case, the selection means 408 are suitable for selecting the reflection means 44 of the optical guide 402 of the matrix 400 and the corresponding reflection means 44 of the optical guide 407 of the matrix 406, and for controlling the respective activation means 47. In this manner the optical signal undergoes a variable delay of between 2D and 2nD.

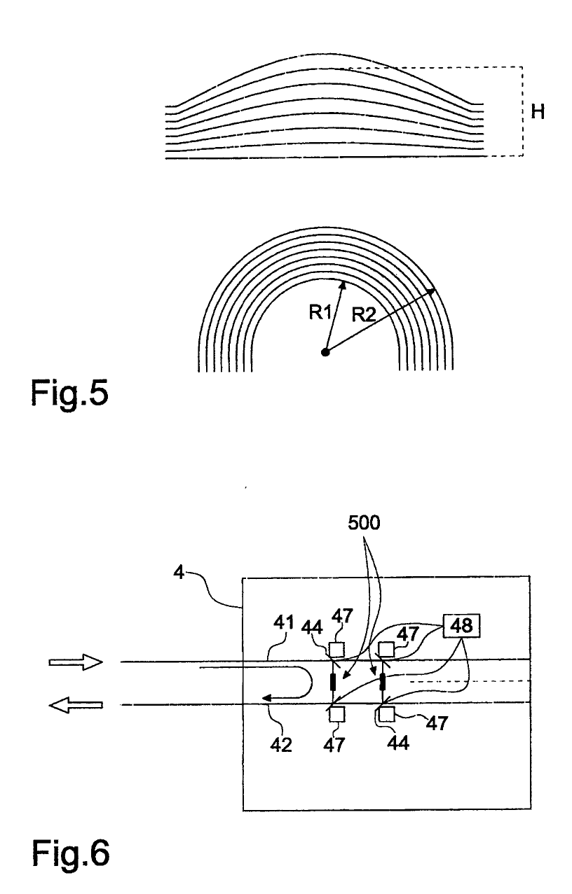

To add further delay to the signal input to the device 4, it is possible to suitably modify the optical delay device of the embodiments shown above. For example, it is possible to vary the length of the optical guides 46. In this case, for example with respect to the device of FIG. 2, the optical guides 46 can be made so as to vary the length as a function of the height H or, in the case of curvilinear optical guides, the length is varied as a function of the radius R, which is between RI and R2, as shown in FIG. 5.

Another possibility to increase the delay of the signal input to the device 4 is to use a heater if the wave guides are in glass. The heater, through the thermal-optical effect, produces a variation of the refraction index of the optical guide. FIG. 6 shows an optical delay device similar to that of FIG. 1 but in which the optical guides 46 are provided with a heater 500. The effect of this heater is to vary by very little the optical path, in comparison to the variation introduced by the delay device described above. In addition, this variation can be controlled continuously after the device is completed, while the choice of the delays possible according to the scheme described above is set once the device is finished. The possibility of introducing this small variation can be useful for fine-tuning the delay lines.

While there has been illustrated and described what are presently considered to be the preferred embodiments of the present invention, it will be understood by those skilled in the art that various other modifications may be made, and equivalents may be substituted, without departing from the true scope of the present invention. Additionally, many modifications may be made to adapt a particular situation to the teachings of the present invention without departing from the central inventive concept described herein. Furthermore, an embodiment of the present invention may not include all of the features described above. Therefore, it is intended that the present invention not be limited to the particular embodiments disclosed, but that the invention include all embodiments falling within the scope of the appended claims.

1. A delay device for receiving an optical signal and outputting a delayed optical signal, said delay device comprising:
at least one first optical guide receiving the optical signal;
at least one optical means outputting the delayed optical signal;
a first plurality of total signal reflection means disposed along the first optical guide, the reflection means being normally inactive;
a plurality of second optical guides placed between the reflection means of the first plurality of reflection means and the at least one optical means;
activation means activating at least one of the reflection means; and
selection means selecting the reflection means of the first plurality of reflection means to be activated to obtain a desired delay of the optical signal,
wherein the reflection means are placed in succession at a distance from one another along the first optical guide.

2. The delay device according to claim 1, wherein the at least one optical means comprises a further optical guide.

3. The delay device according to claim 2,
wherein the further optical guide comprises a second plurality of total signal reflection means positioned along the further optical guide so that each reflection means of the second plurality of reflection means corresponds to one of the reflection means of the first plurality of reflection means of the first optical guide,
the plurality of second optical guides is placed between the corresponding reflection means of the first and second pluralities of reflection means, and
the selection means selects the reflection means of the first plurality of reflection means of the first optical guide and the corresponding reflection means of the second plurality of reflection means to be activated to obtain the desired delay of the optical signal.

4. The delay device according to claim 1, wherein the optical signal is a radio frequency signal carried by a laser signal.

5. The delay device according to claim 1, wherein the second optical guides have variable lengths.

6. The delay device according to claim 5, wherein the second optical guides are curvilinear and have variable lengths as a function of radius.

7. The delay device according to claim 1, wherein the second optical guides comprise means for varying a refraction index of the optical guide.

8. The delay device according to claim 1,
wherein the at least one first optical guide belongs to a matrix of optical guides, and
the at least one optical means comprises an optical splitter.

9. The delay device according to claim 1,
wherein the at least one first optical guide belongs to a matrix of optical guides, and
the at least one optical means comprises at least one further optical guide that belongs to a further matrix of optical guides.

10. The delay device according to claim 1, wherein the reflection means are placed at different distances from one another in the succession.

11. The delay device according to claim 1, wherein the reflection means are placed at equal distances from on another in the succession.

12. A delay device comprising:
at least one first optical guide receiving an optical signal;
at least one optical means outputting a delayed optical signal;
a first plurality of optical switches disposed along the first optical guide, the optical switches being normally inactive;
at least one second optical guide placed between the optical switches of the first plurality of optical switches and the optical splitter;
an activator activating at least one of the optical switches; and
a selector selecting the optical switch of the first plurality of optical switches to be activated to obtain a desired delay of the optical signal,
wherein the optical switches are placed in succession along the first optical guide.

13. The delay device according to claim 12, wherein the optical means comprises at least one further optical guide or at least one optical splitter.

14. The delay device according to claim 13, wherein the optical switches are placed at different distances from one another in the succession.

15. The delay device according to claim 13, wherein the optical switches are placed at equal distances from on another in the succession.

16. A transmission system for transmitting signals, said transmission system comprising:
at least one laser source for transmitting an optical signal;
an emission source for the signals; and
at least one optical delay device for delaying the optical signal, the optical delay device including:
at least one first optical guide receiving the optical signal;
at least one optical means outputting a delayed optical signal;
a first plurality of total signal reflection means disposed along the first optical guide, the reflection means being normally inactive;
a plurality of second optical guides placed between the reflection means of the first plurality of reflection means and the at least one optical means;
activation means activating at least one of the reflection means; and
selection means selecting the reflection means of the first plurality of reflection means to be activated to obtain a desired delay of the optical signal,
wherein the reflection means are placed in succession at a distance from one another along the first optical guide.

17. The transmission system according to claim 16, wherein the emission source comprises a phased array antenna.

18. The transmission system according to claim 16, wherein the at least one optical means of the optical delay device comprises a further optical guide.

19. The transmission system according to claim 18,
wherein the further optical guide of the optical delay device comprises a second plurality of total signal reflection means positioned along the further optical guide so that each reflection means of the second plurality of reflection means corresponds to one of the reflection means of the first plurality of reflection means of the first optical guide,
the plurality of second optical guides of the optical delay device is placed between the corresponding reflection means of the first and second pluralities of reflection means, and
the selection means of the optical delay device selects the reflection means of the first plurality of reflection means of the first optical guide and the corresponding reflection means of the second plurality of reflection means to be activated to obtain the desired delay of the optical signal.

20. The transmission system according to claim 16, wherein the second optical guides of the optical delay device have variable lengths.

21. The transmission system according to claim 16, wherein the reflection means of the optical delay device are placed at different distances from one another in the succession.

22. The transmission system according to claim 16, wherein the reflection means of the optical delay device are placed at equal distances from on another in the succession.
